(19) United States
(12) Patent Application Publication
(10) Pub. No.: US 2002/0191881 A1
(43) Pub. Date: Dec. 19, 2002

(54) Optical isolator

(76) Inventors: Chien-Cheng Chen, Tu-Chen (TW); Jau Jn Dy, Tu-Chen (TW); Tai-Cheng Yu, Tu-Chen (TW); Chun Yu Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 09/940,382

(22) Filed: Aug. 27, 2001

(30) Foreign Application Priority Data
Jun. 15, 2001 (TW) 90210058

(51) Int. Cl. G02B 6/27

(52) U.S. Cl. 385/11; 359/494

(57) ABSTRACT

An optical isolator (10) comprises two similar optical collimators (20), an isolated core (30) and a holder (40). The isolated core comprises a first birefringent crystal (31), an optical nonreciprocal device (33) and a second birefringent crystal (32). The holder has a cylindrical configuration and is formed from metallic material. The holder defines two holes (41) in opposite ends thereof. The collimators are fixed in the two holes, respectively. Three slots (45, 47, 49) are defined in a middle of the holder. The first birefringent crystal, the nonreciprocal device and the second birefringent crystal are respectively fixed into the three slots.

### BACKGROUND OF THE INVENTION

1. Field of the Invention

The present invention relates to optical communications isolators, and particularly to isolators which are easily assembled and are stable.

2. Description of Prior Art

In optical communications, optical signals generally need to pass through a number of optical interfaces. When so passing, the signals generate reflected signals. If the reflected signals travel back to the light source through the primary optical route, the light source becomes unstable and noisy. Optical isolators are used to block the reflected signals from reaching the light source. Ideally, optical isolators permit complete transmission of optical signals in a forward direction and absolutely block transmission of reflected signals in a reverse direction.

A conventional optical isolator includes first and second optical collimators and an isolated core. Each collimator has a ¼ pitch graded index (GRIN) lens, and a ferrule within which an optical fiber is accommodated. The collimators convert input optical signals into parallel light beams, thereby providing good optical coupling therebetween. The isolated core stationed between the two collimators comprises a first birefringent crystal, an optical nonreciprocal device, and a second birefringent crystal. Parallel light beams of an input optical signal from a first optical fiber of a first collimator travel in the forward direction from a first GRIN lens to the first birefringent crystal. The first birefringent crystal separates the incident light into a first ordinary ray polarized perpendicular to an optical axis of the first birefringent crystal, and a second ray polarized along the optical axis of the first birefringent crystal. The nonreciprocal device then rotates the polarized light from the first birefringent crystal 45¢X The nonreciprocal device is typically formed from garnet doped with impurities or YIG, and mounted in a permanent magnet. An optical axis of the second birefringent crystal is oriented by 45¢X with respect to the optical axis of the first birefringent crystal. Thus the ordinary ray from the first birefringent crystal is also the ordinary ray of the second birefringent crystal, and the extraordinary ray from the first birefringent crystal is also the extraordinary ray of the second birefringent crystal. The rotated light beams are then recombined by the second birefringent crystal and refocused by a second GRIN lens to a point on an inner end of a second optical fiber of a second collimator.

In the reverse direction, the second birefringent crystal separates the returned light into an ordinary ray polarized perpendicular to the optical axis of the second birefringent crystal, and an extraordinary ray polarized along the optical axis of the second birefringent crystal. When passing back through the nonreciprocal device, the light in both rays is rotated 45¢X This rotation causes the ordinary ray from the second birefringent crystal to be polarized along the optical axis of the first birefringent crystal, and the extraordinary ray from the second birefringent crystal to be polarized perpendicular to the optical axis of the first birefringent crystal. The parallel light beams of the reflected optical signal exiting the first birefringent crystal are not parallel to the original parallel light beams of the optical signal traveling in the forward direction. Accordingly, the first GRIN lens focuses the reflected light beams to a point away from the end point of the first optical fiber. Thus the reflected light beams do not enter the first optical fiber, and the light source is protected.

FIG. 1 shows a conventional optical isolator 1. The isolator 1 comprises two optical collimators 11 having similar structures, and an optically isolated core 17. Each collimator 11 includes a ferrule 13 with an optical fiber 12 therein, and a graded index (GRIN) lens 14 which is secured in a sleeve 15. The GRIN lens 14 in each collimator 11 has an end portion protruding out from the corresponding sleeve 15. Each sleeve 15 having the ferrule 13 and the GRIN lens 14 therein is secured in a stainless steel tube 16. The isolated core 17 is stationed between the two collimators 11. The isolated core 17 includes a first birefringent crystal 171, a faraday rotator crystal 172, a second birefringent crystal 173, and a toroidal magnetic core 174. The first birefringent crystal 171, faraday rotator crystal 172, and second birefringent crystal 173 are adhered to each other in linear sequence and in that order, and are all secured within the toroidal magnetic core 174.

In assembly, the isolated core 17 having the magnetic core 174 and the crystals 171, 172, 173 is connected with the left-hand collimator 11. This is accomplished by gluing the magnetic core 174 to the left-hand GRIN lens 14. Then the combined isolated core 17 and left-hand collimator 11 is secured in a left-hand end of a tubular holder 18. Finally, the right-hand collimator 11 is inserted into a right-hand end of the holder 18. The position of right-hand collimator 11 in the holder 18 is adjusted so that a space between the right-hand collimator 11 and the combined isolated core 17 and left-hand collimator 11 yields optimal optical characteristics for the isolator 1.

Accurately positioning the right-hand collimator 11 relative to the isolated core 17 in the holder 18 is a meticulous and troublesome task. Furthermore, the isolated core 17 is secured by gluing the magnetic core 174 to the GRIN lens 14. This sometimes results in contamination of the GRIN lens 14 or the first birefringent crystal 171. Such contamination may adversely affect the optical performance of the isolator 1.

Thus, an improved optical isolator that overcomes the disadvantages of the prior art is desired.

### SUMMARY OF THE INVENTION

Accordingly, an object of the present invention is provide an optical isolator that is quickly and easily assembled and that has optical elements positioned therein to yield optimal optical characteristics.

Another object of the present invention is to provide an optical isolator with high optical performance including low insertion loss and high isolation.

To achieve the above objects, an optical isolator of the present invention comprises two similar optical collimators, an isolated core and a holder. The isolated core comprises a first birefringent crystal, an optical nonreciprocal device and a second birefringent crystal. The holder has a cylindrical configuration and is formed from metallic material. The holder defines two holes in opposite ends thereof. The collimators are fixed into the two holes, respectively. Three slots are defined in a middle of the holder. The first birefringent crystal, the nonreciprocal device and the second birefringent crystal are respectively fixed into the three slots.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of a conventional optical isolator;

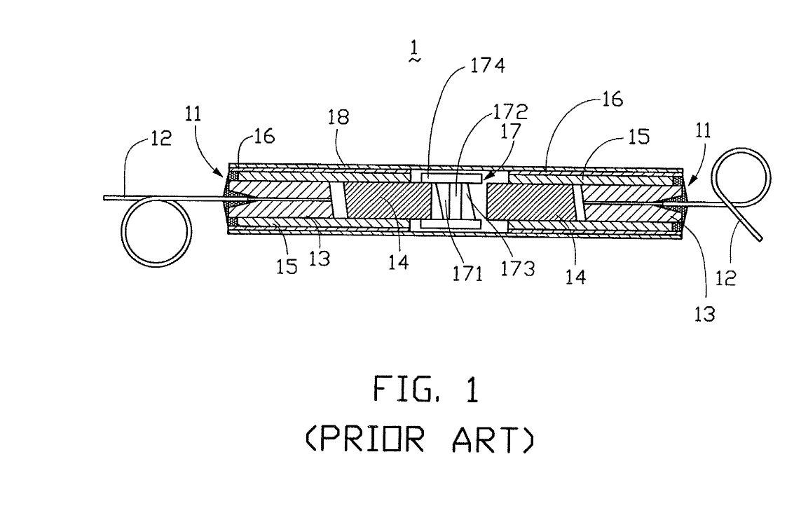

FIG. 2 is an exploded view of an optical isolator in accordance with the present invention; and

FIG. 3 is a cross-sectional view of the optical isolator of FIG. 2.

### DETAILED DESCRIPTION OF THE INVENTION

Reference will now be made to the drawing figures to describe the present invention in detail.

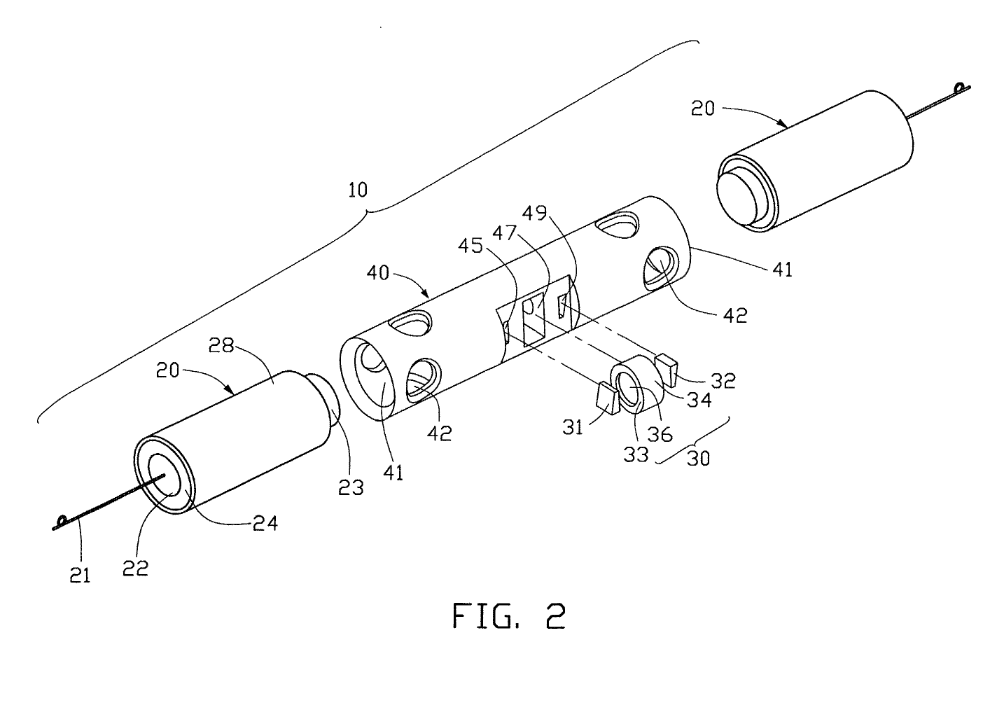

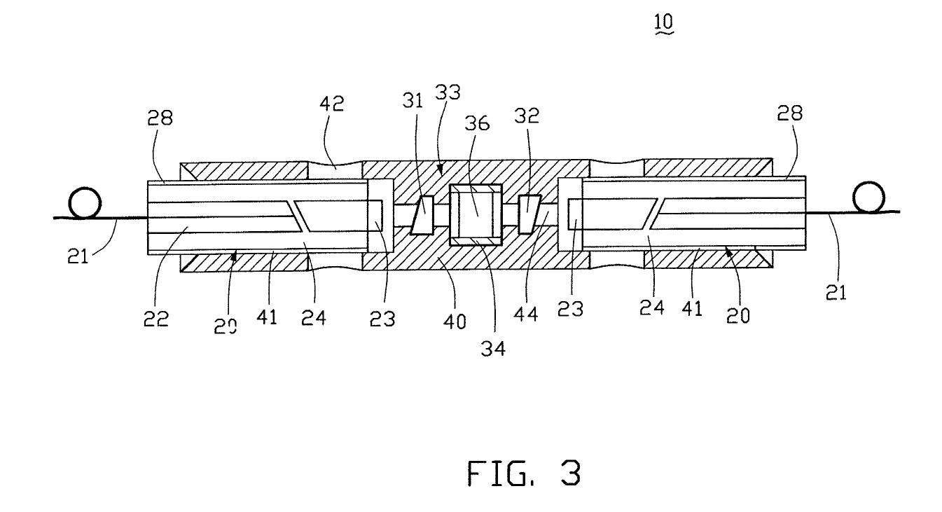

Referring to FIGS. 2 and 3, an optical isolator 10 of the present invention comprises two similar optical collimators 20, an isolated core 30 and a holder 40. Each collimator 20 has a cylindrical configuration, and comprises a ferrule 22, an optical fiber 21 and a GRIN lens 23. The ferrule 22 accommodates the optical fiber 21. The ferrule 22 and the GRIN lens 23 are secured in a sleeve 24. The sleeve 24 is secured within a metallic outer tube 28.

The isolated core 30 comprises a first birefringent crystal 31, a nonreciprocal device 33 and a second birefringent crystal 32. Each first and second birefringent crystal 31, 32 is wedge-shaped, and is made of lithium niobate (LiNbO₃) crystal or other suitable crystal. An optical axis of the second birefringent crystal 32 is oriented by 45¢X with respect to an optical axis of the first birefringent crystal 31. The nonreciprocal device 33 is stationed between the first and second birefringent crystals 31, 32. In the preferred embodiment, the nonreciprocal device 33 is a faraday rotator comprising a toroidal magnetic core 34 and a faraday rotating crystal 36. An axial length of the magnetic core 34 is equal to or slightly greater than an axial length of the faraday rotating crystal 36. The nonreciprocal device 33 can nonreciprocally rotate an incoming optical beam by 45. Light beams from a light source enter the left-hand optical fiber 21 at the left side of FIG. 3. The light beams travel in a forward direction through the left-hand optical fiber 21, the left-hand GRIN lens 23, the first birefringent crystal 31, the faraday rotating crystal 36, and the second birefringent crystal 32. The light beams are then combined by the right-hand GRIN lens 23 to be refocused on a left end of the right-hand optical fiber 21 at the right side of FIG. 3. Optical signals reflected in a reverse direction are combined by the left-hand GRIN lens 23, but are focused to a point away from the left-hand optical fiber 21.

The holder 40 has a cylindrical configuration, and is formed from metallic material. The holder 40 defines two holes 41 in opposite ends thereof respectively. Each hole 41 has a diameter slightly larger than a diameter of the corresponding collimator 20, to enable the collimators 20 to be fixedly secured in the holes 41. Four equidistantly spaced bores 42 are formed in a circumferential periphery of the holder 40 at each opposite end of the holder 40. The bores 42 provide ample access for welding the tubes 28 and the holder 40 together, to thereby fix the collimators 20 in the holder 40. Three slots 45, 47, 49 are defined through a middle portion of the holder 40. The slots 45, 47, 49 are parallel to each other, and perpendicular to a central longitudinal axis of the holder 40. The slots 45, 47, 49 are dimensioned to fittingly receive the first birefringent crystal 31, the nonreciprocal device 33 and the second birefringent crystal 32 respectively. A passageway 44 is defined in a middle portion of the holder 40, between and in communication with the holes 41. The passageway 44 is also in communication with the slots 45, 47 and 49. A diameter of the passageway 44 is about from 400 to 500 μm, for allowing transmission of optical signals therethrough.

In assembly, the first birefringent crystal 31, the nonreciprocal device 33 and the second birefringent crystal 32 are respectively inserted into the slots 45, 47 and 49 of the holder 40. The first and second birefringent crystals 31, 32 and the nonreciprocal device 33 are fixed in the slots 45, 47, 49 by gluing the first and second birefringent crystals 31, 32 and the nonreciprocal device 33 to the holder 40. The holder 40 and each outer tube 28 are welded together via the corresponding bores 42, to fixedly attach the collimators 20 to the holder 40. Assembly of the optical isolator 10 is thereby completed.

It can be appreciated by those skilled in the art that before welding, the positions of the collimators 20 are adjusted relative to the isolated core 30 until predetermined optical characteristics are attained. Then, the collimators 20 are respectively inserted into the holes 41 of the holder 40. The slots 45, 47, 49 are dimensioned to fittingly receive the first birefringent crystal 31, the nonreciprocal device 33 and the second birefringent crystal 32 respectively, and the positions of the three slots 45, 47, 49 and the two holes 41 are accurately orientated by precision engineering. It is therefore not necessary to adjust the relative positions of the isolated core 17 and the two collimators 11 in the holder 18. This saves considerable time and effort. In addition, the first and second birefringent crystals 31, 32 and the nonreciprocal device 33 are respectively fixed to the holder 40 in the slots 45, 47, 49. It is therefore not necessary to adhere the first and second birefringent crystals 31, 32 and the nonreciprocal device 33 to each other or to the magnetic core 34. This not only saves considerable time and effort, but also eliminates the risk of excess glue contaminating the first and second birefringent crystals 31, 32 or the nonreciprocal device 33. Furthermore, it is not necessary to adhere the magnetic core 34 to an end of the left-hand GRIN lens 23. This eliminates the risk of excess glue contaminating the left-hand GRIN lens 23. Moreover, the holder 40 provides protection for the first and second birefringent crystals 31, 32. It is therefore not necessary to adhere the first and second birefringent crystals 31, 32 within the magnetic core 34. This eliminates the risk of excess glue contaminating the first and second birefringent crystals 31, 32.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical isolator comprising:
two optical collimators, each collimator including a ferrule, an optical fiber accommodated in the ferrule, and a graded index lens;
an isolated core comprising a first birefringent crystal, an optical nonreciprocal device and a second birefringent crystal; and
an elongate holder defining two holes at opposite ends thereof, each hole receiving one collimator therein, at least one slot being transversely defined through the holder between the holes, at least one of the group of first birefringent crystal, optical nonreciprocal device, and second birefringent crystal being received in the at least one slot, a passageway being defined through the holder between the holes to optically connect the collimators and the isolated core.

2. The optical isolator as described in claim 1, wherein three slots are transversely defined through the holder between the holes, and the three slots are dimensioned to respectively correspond to dimensions of the first birefringent crystal, the nonreciprocal device and the second birefringent crystal, whereby the first birefringent crystal, the nonreciprocal device and the second birefringent crystal are respectively fitted in the slots.

3. The optical isolator as described in claim 1, wherein the holder is formed from metallic material.

4. The optical isolator as described in claim 3, wherein each optical collimator has a metal tube receiving the corresponding ferrule and corresponding GRIN lens therein, each metal tube being fitted in a corresponding hole of the holder.

5. The optical isolator as described in claim 3, wherein three slots are transversely defined through the holder between the holes, and the three slots are dimensioned to respectively correspond to dimensions of the first birefringent crystal, the nonreciprocal device and the second birefringent crystal, whereby the first birefringent crystal, the nonreciprocal device and the second birefringent crystal are respectively fitted in the slots.

6. The optical isolator as described in claim 5, wherein the holder defines at least one bore near each of the opposite ends thereof, and the holder and each tube are welded together via the corresponding at least one bore.

7. The optical isolator as described in claim 1, wherein the nonreciprocal device is a faraday rotator comprising a toroidal magnetic core and a faraday rotating crystal mounted in the magnetic core, the magnetic core having a length equal to or slightly greater than a length of the faraday rotating crystal.

8. An optical isolator comprising:
a generally cylindrical holder defining two longitudinal holes in opposite ends thereof, adjacent first, second and third slots between the holes and perpendicular to the holes, and a passageway communicating with the holes and with the slots; and
two optical collimators respectively fixedly received in the two holes, and a first birefringent crystal fixedly received in the first slot, an optical nonreciprocal device fixedly received in the second slot, and a second birefringent crystal fixedly received in the third slot.

9. The optical isolator as described in claim 8, wherein the optical nonreciprocal device is a faraday rotator, and the faraday rotator comprises a magnetic core and a faraday rotating crystal received in the magnetic core.

10. The optical isolator as described in claim 8, wherein the collimators are welded to the holder.

11. An optical isolator comprising:
two opposite optical collimators, each of said two collimators including an outer ferrule enclosing an optical fiber therein, and an inner graded index lens;
an isolated core disposed between said two collimators, said isolated core including first and second birefringent crystals together sandwiching a nonreciprocal device therebetween; and
a holder defining a cylindrical configuration with at two opposite ends thereof opposite two holes in communication with an exterior along an axial direction of the holder, and around a middle portion thereof at least one slot in communication with the exterior along a radial direction of the holder; wherein
said two collimators are inwardly inserted into the holder from said two holes along said axial direction of said holder, and said isolated core is inwardly inserted into the slot along said radial direction of said holder.

12. The isolator as described in claim 11, wherein said holder defines three spaced slots along said axial direction to receive the first birefringent crystal, the nonreciprocal device and the second birefringent crystal, respectively.

13. The isolator as described in claim 11, wherein there is no direct attachment between the isolated core and anyone of said two collimators.

14. The isolator as described in claim 11, wherein the slot of the holder is dimensioned to snugly receive the corresponding isolated core without substantial improper relative axial movement therein.
